(19) United States
(12) Patent Application Publication
(10) Pub. No.: US 2018/0274240 A1
(43) Pub. Date: Sep. 27, 2018

(54) Downspout Connector

(71) Applicant: David Kilbert, San Luis Obispo, CA (US)

(72) Inventor: David Kilbert, San Luis Obispo, CA (US)

(21) Appl. No.: 15/909,997

(22) Filed: Mar. 1, 2018

Related U.S. Application Data
(60) Provisional application No. 62/474,893, filed on Mar. 22, 2017.

(51) Int. Cl. E04D 13/08; F16L 25/00; F16L 41/02

(52) U.S. Cl. CPC E04D 13/08; F16L 25/0009; E04D 2013/082; E04D 2013/0813; F16L 41/02

(57) ABSTRACT

Downspout connector consists of an attachment system for joining to open end of a downspout. The apparatus is hand-fastened to downspout without need of physical or permanent drain modification. The apparatus interface permits fluid movement through duct(s) to threaded hose connector. A conventional hose joins with threaded hose connector(s) for fluid distribution to remote locations. Downspout connector presents an easier, more efficient device for diverting and dispersing rainwater.

### FIELD OF THE INVENTION

The present invention relates generally to devices for diverting water from a downspout. Specifically, the invention relates to an attachment for a downspout, enabling passive water distribution by way of conventional water hoses to desired locations without physical or permanent drain modification.

### BACKGROUND OF THE INVENTION

The concept of rainwater harvesting has become popular recently with climate variations and urban water restrictions. Nowadays, homeowners search for ways to conserve and use water more efficiently, especially rainwater. There are significant benefits for diverting rainwater such as extra water for lawns, gardens, and landscaping, as well as specific targeting to desired locations. Also, it is generally preferred to remove rainwater away from a building to prevent local flooding, ponding, or structural damage. A properly designed rainwater diverter allows users to remove water away from structures by way of conventional water hoses to remote locations. Lastly, rainwater diverters offer users economic rewards. For example, a 1000 ft.² roof with one inch of rainfall yields approximately 620 gallons of extra water, thereby reducing municipal water expenses for landscape needs. Related art has tried to capture rooftop rainwater through drain pipe diverters and rain barrel collection systems.

Most rainwater diversion devices require drain pipe modification by cutting, drilling, or adding specialized ducts. For example, some said devices (Guinyard, US Pat. No. 20120247580A1; Shaw, US Pat. No. 20040200781) require removal of a standard downspout for permanent replacement by a close-end system with hose attachment. These permanent alterations may lead to additional maintenance later, like unclogging or leaking, and may appear aesthetically unpleasing. Similarly, specialized duct attachments are used in other rainwater diverters (Teoh, US Pat. No. 20110290355A1), requiring skilled art in cutting and modifying drain pipes. It is preferred that a water diverting device be easily attached to only the downspout opening, and that such device be joined without physical or permanent drain modification.

Other related art presents devices that do not capture all rainwater in a drain pipe. One such device (Schmidt, US Pat. No. 20110041416) only diverts rainwater if it runs along the inside of the drainpipe wall, permitting water loss if it runs down the center of the pipe. It is preferred that a water diverting device enable collection and diversion of all water in a drain system.

Most of said devices also require a large storage barrel (Block, US Pat. No. 20100270219) to absorb the diverted rainwater, creating potential for overflow and flooding. While other devices, like downspout extensions (Smith, U.S. Pat. No. 8,689,837B1) attempt directing water away from a building. However, these extensions are usually short accordion-style devices of no more than a few feet, with local flooding still possible. It is preferred that a water diverting device permit immediate water removal to greater remote locations by way of conventional hose attachments.

Despite these advances in water conservation, all said devices have limitations, and present a need for a simpler, portable, and more efficient apparatus for harvesting rainwater.

### BRIEF SUMMARY OF THE INVENTION

The following is intended to be a brief summary of the downspout connector of the present invention and is not intended to limit the scope of the invention. To achieve the objectives and in accordance with the purpose of the invention, a downspout connector requiring no physical or drain modification to disperse water via conventional water hoses is presented.

The general purpose of the present invention is to provide a mechanism for diverting water from a downspout by way of a downspout connector. Three of the many present invention advantages: (1) The invention is easily attached, secured, and removed, enabling convenient downspout clean-out and no need for physical or permanent drain modification. (2) The invention enables all collected roof water to be available for vegetation and landscape use, thereby eliminating water waste. (3) With water hoses attached, rainwater is immediately diverted to remote locations, thereby reducing potential ponding, flooding, or structural damage. These three advantages combined make the present invention unique and novel.

A primary object of the present invention is a downspout connector permitting conventional water hose attachment directly to a downspout. The invention joins to the downspout opening and is secured by a tongue-and-groove attachment structure, with a gasket interface between the downspout opening and tongue-and-groove channels enabling a watertight seal. Water exits the downspout, entering the connector interface through two channeling ducts. Water transfers through the ducts and exits through hollow, threaded hose connectors, where it is distributed by a method of two (or optionally one) attached conventional water hoses.

In one embodiment, the present invention is configured for joining the open end of a downspout. Water exits the downspout and channels through the connector interface via two ducts. Once through the ducts, water is directed through threaded hose connectors and disperses by way of attached water hoses.

In another embodiment, the present invention provides a mechanism for fitting the downspout edges into device channels by way of a tongue-and-groove attachment structure. The purpose of channels is to hold device into place while hand-tightened fasteners secure the device.

In another embodiment, the present invention is secured to the downspout by process of thumbscrew fasteners held in place by threaded shafts or other fasteners, e.g. Once the fasteners are tightened, enough force is applied to downspout edge against the channel wall to secure device to downspout. This solves the problem of physical or permanent drain modification.

In another embodiment, the present invention may be sealed by structure of a gasket pressed against downspout to reduce leaking. The gasket interfaces between the connector channels and downspout. Applied pressure against the downspout, in conjunction with fasteners, provides a watertight coupling. Since all drain water is now capable of collection, this solves the problem of wasted water.

In another embodiment, the present invention includes hose connectors for mechanism of joining conventional water hoses. The hose connectors provide a hollow duct for joining the device interface with water hoses. The hose connectors may include exterior male threading, for joining of hose(s) to disperse water to remote areas. This solves the problem of local ponding, flooding, and potential structural damage. It also excludes the need of water barrels for storage.

In another embodiment, the present invention includes a body having a wall that overlaps the outer wall of the downspout, thereby enclosing the downspout exit hole with purpose of diverting fluid. A tongue-and-groove attachment structure includes a channel for receiving the downspout and secures the downspout connector to the downspout by way of at least one reversible fastening mechanism, wherein no physical modification of the downspout is necessary to attach the downspout connector.

In another embodiment, the present invention includes at least one hose connector on the device with purpose to facilitate transfer of fluid from downspout exit hole to attached water hose(s). At least one hose connector includes an elevated base with thicker diameter and walls for purpose of reducing shearing and weight stress on hose connectors and overall device. At least one hose connector is male threaded, enabling attachment of conventional female-threaded water hoses for fluid distribution. The said hose connectors are positioned on the device body at the horizontal midline.

In another embodiment, the present invention includes at least one duct, preferably two, positioned on the horizontal midline of the downspout connector with purpose of enabling fluid transfer from downspout exit hole through the device body into attached hoses.

In another embodiment, the present invention includes a gasket comprised of a compressible material positioned on the interfacing side of the device body, such that the gasket provides a watertight seal when downspout connecter and downspout are coupled by compression. The gasket adheres to the device body and is situated within sidewalls of the device body, protecting the gasket from weather. The gasket comprises a thickness greater or equal to the width of the sidewall. A portion of the gasket is located within a channel for purpose of providing a watertight seal as channel guides downspout connector into place over the downspout.

In another embodiment, the present invention includes gussets and ribbing with purpose of providing structural support. For example, walls of at least one channel are connected to the device body by supporting gussets. Likewise, ribbing provides support between at least one tongue-and-groove attachment structure and channel.

Other features, advantages, and objects of the present invention will become more apparent and more readily understood with the following drawings read in conjunction with accompanying detailed description.

### BRIEF DESCRIPTION OF THE DRAWINGS

The features and advantages of the present invention will become better understood by way of example, and not by way of limitation, with the following detailed descriptions and accompanying drawings, wherein:

FIG. 1 presents an exemplary front perspective view of downspout connector attached to downspout with conventional water hose of the present invention;

FIG. 2 presents a magnified exemplary front perspective view of the present invention;

FIG. 3 presents an orthographic front view of the present invention;

FIG. 4 presents an orthographic top and bottom view of the present invention;

FIG. 5 presents an orthographic rear view of the present invention;

FIG. 6 presents an orthographic side view of the present invention; and

FIG. 7 presents an orthographic partially cut side view of the present invention.

Figures are not necessarily drawn to scale unless otherwise indicated.

### REFERENCE NUMERALS IN THE DRAWINGS

| | |
|---|---|
| 1 | building |
| 2 | drain pipe |
| 3 | downspout |
| 4 | downspout elbow |
| 5 | water hose |
| 6 | downspout connector |
| 7 | hose connector(s) |
| 8 | hose connector threads |
| 9 | fastener(s) |
| 10 | connector interface |
| 11 | duct exit |
| 12 | fastener gusset(s) |
| 13 | base(s) |
| 14 | tongue-and-groove attachment structure |
| 15 | gasket |
| 15a | gasket perimeter portion |
| 15b | gasket perimeter portion |
| 16 | duct entrance(s) |
| 17 | duct(s) |
| 18 | fastener shaft(s) |
| 19 | internal threads |
| 20 | tongue-and-groove channels |
| 21 | body sidewall |
| 22 | channel wall gusset(s) |
| 23a | front ribbing |
| 23b | top ribbing |
| 23c | top inside ribbing |
| 24 | channel wall |

### DETAILED DESCRIPTION OF THE INVENTION

The present invention and its various other objects, features, and advantages will become fully understood by reference to the detailed figures and descriptions set forth herein.

It is understood those skilled in the art will recognize multiple methods and procedures to suitably apply, implement, or modify the present invention. Said variations and modifications are too numerous to be listed but that all fit within the scope of the invention. The forthcoming embodiments and related discussion of the present invention are also intended for explanatory purposes, and the invention extends beyond the embodiments and examples set forth in the following description.

It is also understood that the present invention is not limited by materials or manufacturing techniques, processes, or devices. Those skilled in the art will recognize multiple variations for materials and manufacturing of the present invention, and all are within the scope without limitation of the invention. The described embodiments are provided only as examples and are not intended to be limiting in any way.

The embodiments generally refer to rainwater as preferable fluid of the present invention and are used in the Application merely as a common example. However, the invention is not limited to use by rainwater and incorporates all fluids able to pass through a downspout or duct system.

The present invention will now be described in detail with reference to accompanying Figures.

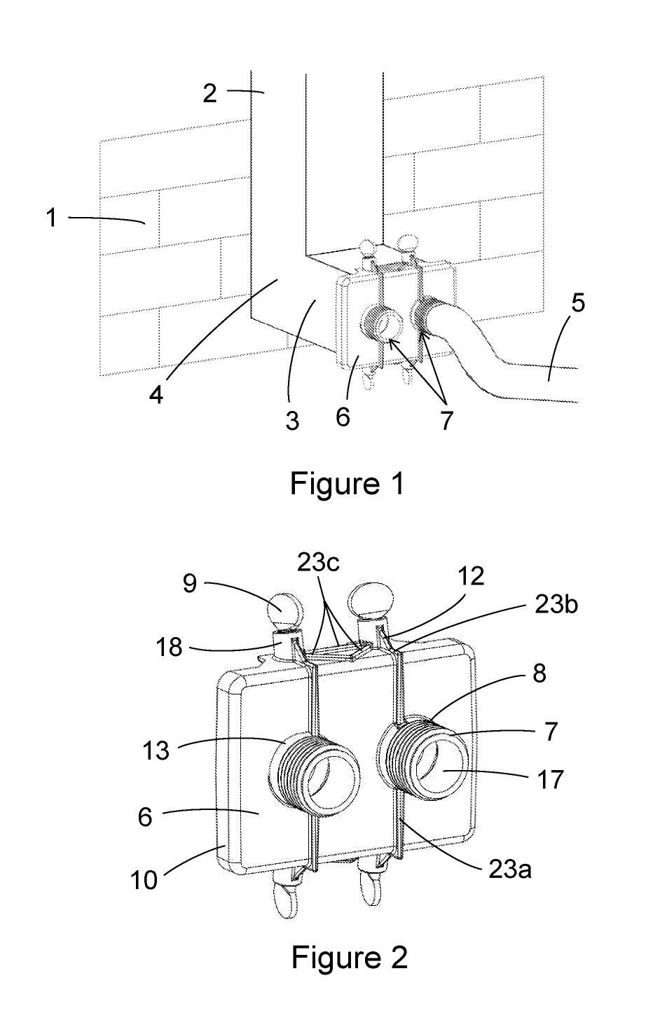

FIG. 1 illustrates an exemplary front perspective view of the downspout connector 6. In the present embodiment, a building's 1 rooftop gutter system collects rainwater which transports through a drain pipe 2. Rainwater transfers through the downspout elbow 4 and exits the downspout 3. The downspout connector 6 joins the downspout opening, and water travels through the device by way of two ducts. Water leaves ducts and passes through hose connectors 7, where two (or optionally one) joined conventional water hoses 5 distribute water to remote locations.

In the present embodiment, the downspout connector 6 is oriented horizontally. It is generally known building downspouts 3 may require the downspout connector 6 be oriented horizontally, vertically, diagonally, inverted, or other position. The present invention may be disposed in any of said positions in alternate embodiments with or without device additions or modifications.

In the present embodiment, hose connectors 7 comprise of standard, male threads providing a mechanism for attachment. However, in alternate embodiments various different methods may also be employed for attaching hoses. For example, using female threads, no threads, clip-on devices, hook and loop fasteners, compression, or various other methods are all included within the scope of the present invention. Similarly, multiple hose attachment methods may be used in alternate embodiments. For example, flexible and rigid materials like metal, plastic, composites, rubber, or other water dispersing devices in temporary or permanent attachment form are within the scope of the present invention.

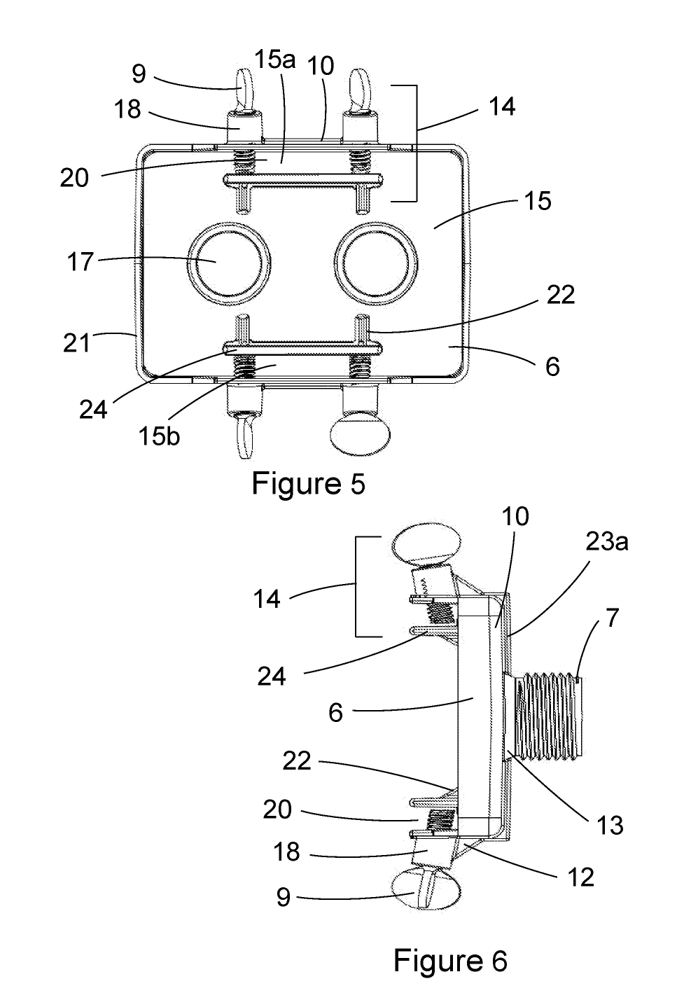

FIG. 2 illustrates a magnified exemplary front perspective view of downspout connector 6. In the present embodiment, the downspout connector 6 generally comprises of a device having a mechanism for joining the downspout with a tongue-and-groove attachment system (see FIG. 5), secured in position by fasteners 9. A gasket (see FIG. 5) attached to the backside of connector interface 10 provides a watertight seal when downspout connector 6 joins to downspout. With the device joined to downspout, downspout connector interface 10 blocks water exiting downspout and channels it through two ducts 17. Ducts 17 enable water flow to transfer through hose connectors 7, where two (or optionally one) attached conventional water hoses may distribute water to a remote location.

Although a detailed exemplary method for constructing the downspout connector 6 is described in the following, those skilled in the art will recognize various types of different construction methods and materials. The preferred construction method and material of the present invention is plastic injection molding, generally producing one whole device, with commercially available metal thumbscrew fasteners. Alternate construction methods and materials may include without limitation the following: molding, casting, welding, handwork, adhering, extruding, 3-D printing, or various other; using such materials as metal, wood, rubber, plaster, ceramic, concrete, composite, fiberglass, or various other.

The bulk of material on downspout connector 6 is the connector interface 10, comprising of front and back halves. The connector interface 10 incorporates two ducts 17, wherein water is permitted to transfer freely through downspout connector 6. It is to be understood that the scope of the present invention includes downspout connector configurations that include a single duct, two ducts, or three ducts, which may be in various arrangements (two or three ducts aligned horizontally, a single central duct, a single duct located near the perimeter of the interface, etc.).

The back half of connector interface 10 comprises generally of a tongue-and-groove attachment structure (see FIG. 5), for guiding and joining downspout connector 6 onto downspout. Fasteners 9 fit into respected fastener shafts 18 in the sidewalls of the connector 10, generally situated on top and bottom of downspout connector 6. Hand-tightened fasteners 9 secure invention onto downspout by pinching and applying pressure to the wall of the downspout 3. Some alternate fasteners may include thumbscrews with pointed, round, square, or blunt tips; various screws; snap-fit; locking clamps; nut and bolt combinations; tongue-and-groove techniques; rivets; pins; mechanisms involving cinching, tying, or hook-loops; etc.

The connector interface 10 has sidewalls that overlap with the distal edge of the downspout 3. The sidewalls may have width in the range of about 4 mm to about 40 mm, which may provide a frictional engagement with the outer surface of the downspout 3. In some embodiments, sidewall may include a portion having a greater width than other portions of the sidewall to allow fasteners 9 to be position on and through the sidewall. In some embodiments, the interior surface of the of the sidewalls (the surface that interfaces with the outer surface of the downspout) may have a roughened, tacky, or otherwise creates a high coefficient of friction (e.g., a static coefficient of friction in a range of about 0.75 to about 2) between the interior surface of the sidewalls and the outer surface of the downspout 3. For example, the interior surface of the sidewalls may have a plastic material that is scored with fine striations to create fine sharp edges that bite into the exterior surface of the downspout 3 when pressure is applied. In other examples, the interior surface of the sidewall may include a rubber material or lining that creates a high coefficient of friction. In still other examples, the interior surface of the sidewall may be coated with glue, resin, paint, or other tacky film that may include the static coefficient of friction. It is to be understood that embodiments of the present invention may include combinations of the features for increasing the coefficient of friction discussed above.

The front half of downspout connector 6 comprises of an elevated base 13 (preferably two) situated on center lines of connector interface 10. The base 13 adds structural support for hose connectors 7, reducing shearing and weight stress. Standard male hose connector threads 8 protrude from the exterior wall of the hose connectors 7. Conventional water hoses join to hose connectors 7, distributing fluid to remote locations.

The present embodiment presents external support structures that may include ribbing, gussets, and other structural features with purpose to increase integral strength of the device. The structures function to reduce bending and shearing of connector interface 10 and downspout connector 6. The preferred shape, size, and proportion of external support structures are shown in present embodiment. Preferable half-round external front ribbing 23a is located on the vertical plane of connector interface 10, intersecting connector bases 13. Front ribbing 23a joins continuously with top ribbing 23b. Top ribbing 23b is generally situated on top and bottom of connector interface 10 and joins with fastener gussets 12 to reinforce connector interface 10 with fastener shafts 18. Top inside ribbing 23c, generally in a triangular formation, is located on top and bottom of connector interface 10 between fastener shafts 18 with purpose to reduce bending, twisting, and other forces. Fastener gussets 12, generally triangular shaped, join with top ribbing 23b, connecting fastener shafts 18 to horizontal plane of connector interface 10 and provide additional structural support. Alternate embodiments may include without limitations external support structures comprised of different sizes, shapes, materials, and proportions. For example, gussets and ribbing may be half-round, rectangular, triangular, cylindrical, or other various shapes and sizes. Various other support structures may also be presented as beveled, flat, raised, tapered, or other forms. In addition, all support structures may be arranged in a grid, rectangular, spherical, or various other configurations. Preferred material is molded plastic as part of an overall one-piece molded device. However, support structures may be constructed of metal, wood, ceramic, composite, plastic, rubber, or various other materials. Similarly, all support structure variations, or those realized by the skilled art, are within the scope of the present invention.

In operation, a typical user fits downspout connector 6 onto downspout with aid of tongue-and-groove attachment channels (see FIG. 5). The user pushes downspout connector 6 onto downspout and holds, ensuring the gasket forms a watertight seal. Once the device is held in place, user then tightens thumbscrew fasteners 9 by hand, slowly while alternating, until downspout connector 6 is secured. User attaches two (or optionally one) conventional water hoses. The quick installation/removal of present invention enables a convenient process for downspout clean-out, movement to other locations, and easy storage during times of non-use. The objectives of present invention are to (1) remove drain water away from building to more remote locations, thereby reducing potential ponding, flooding, or structural damage; (2) provide extra drain water for vegetation and landscape, thereby reducing waste; (3) join a water conservation device to a downspout without need for physical or permanent modification.

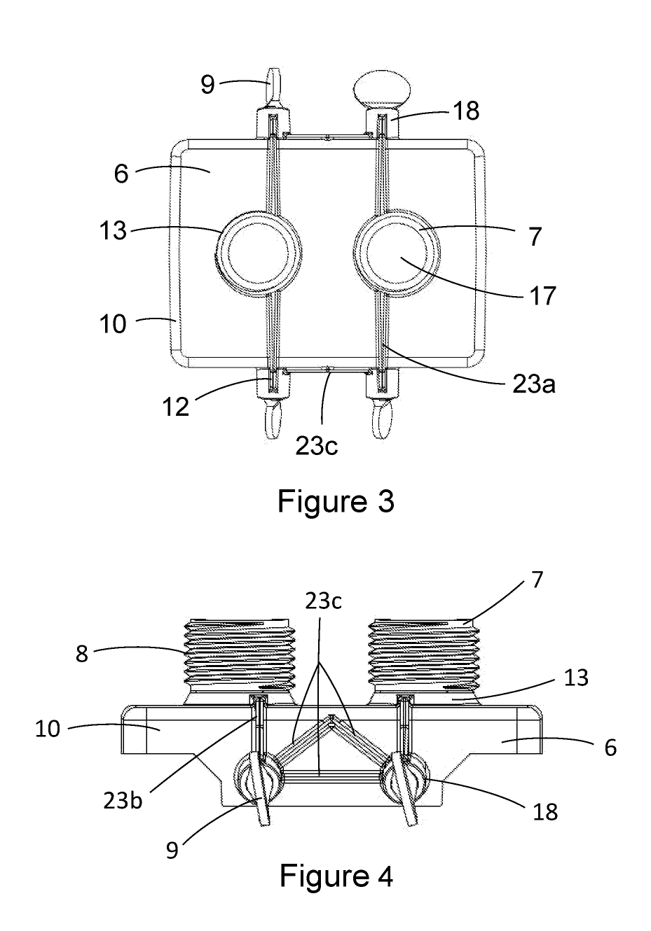

FIG. 3 presents an orthographic front view of downspout connector 6. In the present embodiment, downspout connector 6 comprises of two ducts 17, enabling water transfer from downspout to attached water hoses. Connector interface 10 provides a blocking mechanism when attached to downspout, enabling water to channel through ducts 17. Situated on connector interface 10 is an elevated base 13, providing structural support for male-threaded hose connectors 7. Hose connectors 7 provide an attachment mechanism for conventional water hoses to distribute water to desired locations. Fasteners 9 are one component of the tongue-and-groove attachment structure (see FIG. 5) and are situated generally on top and bottom of connector interface 10. Fasteners 9 fit into respected fastener shafts 18, also situated on top and bottom of connector interface 10. Hand-tightened fasteners 9 secure downspout connector 6 onto downspout by pinching pressure.

The present embodiment presents external support structures that may include ribbing, gussets, and other structural features with purpose to increase integral strength of the device. The structures function to reduce bending and shearing of connector interface 10 and downspout connector 6. The preferred shape, size, and proportion of external support structures are shown in present embodiment. Preferable half-round external front ribbing 23a is located on the vertical plane of connector interface 10, intersecting connector bases 13. Front ribbing 23a joins continuously with top ribbing 23b (see FIG. 4). Top ribbing 23b is generally situated on top and bottom of connector interface 10 and joins with fastener gussets 12 to reinforce connector interface 10 with fastener shafts 18. Top inside ribbing 23c is located on top and bottom of connector interface 10 between fastener shafts 18 with purpose to reduce bending, twisting, and other forces. Fastener gussets 12, generally triangular shaped, join with top ribbing 23b (see FIG. 4), connecting fastener shafts 18 to horizontal plane of connector interface 10 and provide additional structural support. Alternate embodiments may include without limitations external support structures comprised of different sizes, shapes, materials, and proportions. For example, gussets and ribbing may be half-round, rectangular, triangular, cylindrical, or various other shapes and sizes. Support structures may also be presented as beveled, flat, raised, tapered, or various other forms. In addition, support structures may be arranged in a grid, rectangular, spherical, or various other configurations. Preferred material is molded plastic as part of an overall one-piece molded device. However, support structures may be constructed of metal, wood, ceramic, composite, plastic, rubber, or various other materials. Similarly, all support structure variations, or those realized by the skilled art, are within the scope of the present invention.

In the present embodiment, two ducts 17 are shown at the preferable horizontal midline of connector interface 10. Alternate embodiments include without limitation ducts 17 or hose connectors 7 positioned above or below horizontal midline, left or right of vertical midline, diagonally, asymmetrically from midlines, or other various positions. Likewise, the present embodiment preferably illustrates two ducts 17 on downspout connector 6. However, those skilled in the art may readily recognize additional or fewer ducts 17 of various sizes on the invention, including without limitation one, two, three, four, or more ducts 17. This also includes joining specialized attachments to ducts 17 or hose connectors 7 with purpose of dispersing water by multiple operations. All devices, techniques, and structures described or later recognized are within the scope of the present invention.

In the present embodiment, an elevated base 13 comprised of thickened material joins connector interface 10 and hose connectors 7. The base 13 provides structural support to hose connectors 7 and increases general durability of invention. The preferred shape, size, and proportion of base 13 are shown in present embodiment. The preferred shape is circular and constructed of plastic, as part of an overall one-piece injection molded device. Alternate embodiments may include without limitations a base 13 comprised of different shapes, materials, and proportions. For example, base 13 may be rectangular, triangular, hexagonal, or various other shapes. It may be constructed of metal, wood, ceramic, composite, plastic, concrete, rubber, or other material. The base 13 form may include beveled, flat, raised, tapered, or other various configurements. All described base 13 variations, or those realized by skilled art, are within the scope of the present invention.

FIG. 4 illustrates an orthographic top and bottom view of present invention. In the present embodiment, downspout connector 6 comprises of connector interface 10, providing a blocking mechanism when attached to a downspout, enabling water to channel through ducts. The connector interface 10 consists of front and back halves. Elevated on front half connector interface 10 is the base 13, constructed of thickened material and providing structural support for hose connectors 7. Hose connectors 7, comprised of male hose connector threads 8, provide an attachment mechanism for conventional water hoses to distribute water to desired locations. Located on back half of connector interface 10 is a tongue-and-groove attachment structure (see FIG. 5). Two components of said structure include fasteners 9 and fastener shafts 18 situated generally on top and bottom of connector interface 10.

The present embodiment presents external support structures that may include ribbing, gussets, and other structural features with purpose to increase integral strength of the device. The structures function to reduce bending and shearing of connector interface 10 and downspout connector 6. The preferred shape, size, and proportion of external support structures are shown in present embodiment. Preferable half-round external front ribbing 23a (see FIG. 3) is located on the front half of connector interface 10, intersecting connector bases 13. Front ribbing 23a joins continuously with top ribbing 23b. Top ribbing 23b is generally situated on top and bottom of connector interface 10 and joins with fastener gussets 12 (see FIG. 2) to reinforce connector interface 10 with fastener shafts 18. Top inside ribbing 23c, generally in triangular formation, is located on top and bottom of connector interface 10 between fastener shafts 18 with purpose to reduce bending, twisting, and other forces. Fastener gussets 12, generally triangular shaped, join with top ribbing 23b, connecting fastener shafts 18 to connector interface 10 and provide additional structural support. Alternate embodiments may include without limitations external support structures comprised of different sizes, shapes, materials, and proportions. For example, gussets and ribbing may be half-round, rectangular, triangular, cylindrical, or various other shapes and sizes. Support structures may also be presented as beveled, flat, raised, tapered, or various other forms. In addition, support structures may be arranged in a grid, rectangular, spherical, or various other configurations. Preferred material is molded plastic as part of an overall one-piece molded device. However, support structures may be constructed of metal, wood, ceramic, composite, plastic, rubber, or various other materials. Similarly, all support structure variations, or those realized by the skilled art, are within the scope of the present invention.

FIG. 5 illustrates an orthographic rear view of the present invention. In the present embodiment, downspout connector 6 comprises of connector interface 10, providing a blocking mechanism when attached to downspout, enabling water to channel through ducts 17. Situated on back half of connector interface 10 is a tongue-and-groove attachment structure 14, comprising of the following components: tongue-and-groove channels 20, channel walls 24, channel wall gussets 22, fasteners 9, fastener shafts 18, body sidewall 21, and gasket 15.

In the present embodiment, tongue-and-groove channels 20 permit downspout edge (“tongue”) to join attachment channel (“groove”). The preferably two tongue-and-groove channels 20 and their corresponding channel walls 24 guide downspout into position, enabling proper fit. Tongue-and-groove channels 20 are situated generally on top and bottom of backside downspout connector 6. Preferably two channel wall gussets 22 provide strength to each channel wall 24, reducing bending, twisting, and other forces. Fasteners 9 secure downspout to channel wall 24 by pinching pressure. Channel wall gussets 22 are generally right-triangular shaped, joining connector interface 10 with tongue-and-groove channel walls 24 in a perpendicular manner.

Channel walls 24 generally correspond to the same length as the distance between fastener shafts 18. Each channel wall 24 is preferably one elongated piece generally rectangular. In alternate embodiments, channel walls 24 may also include multiple pieces or may form one continuous perimeter around the ducts 17. Likewise, channel walls 24 may also include various other shapes and configurations such as ellipses, triangles, cylinders, in such forms as grids, right angles, solid blocks, etc.

Preferable material is plastic as part of an overall one-piece molded device for both tongue-and-groove channels 20, channel walls 24, and channel wall gussets 22. In alternative embodiments, tongue-and-groove channels 20, channel walls 24, and channel wall gussets 22 may be oriented in various different positions and in various different forms. For example, the said components may be positioned parallel to the width of the device, form a continuous perimeter around the device, or provide support in the form of attached right angles. Likewise, the present embodiment shows preferably two channels with four supports. However, those skilled in the art may readily recognize more or less channels and supports. All variations providing a similar function of guidance and support in the attachment process are within the scope of the present invention.

With downspout connector 6 fitted onto downspout, fasteners 9 are inserted into fastener shafts 18 as a mechanism for securing invention onto downspout. Hand-tightened fasteners 9 secure downspout connector 6 to downspout by pinching pressure, with no need for mechanical methods or operations. In the preferred embodiment, fasteners 9 are commercially available spade-head, male-thread thumbscrews. Metal is the preferred thumbscrew material; however, other fastener 9 materials may also include plastic, wood, composite, or various different metals, with such coatings as paint, powder coat, zinc, nickel, chrome, stainless steel, brass, and other. In addition, alternate temporary or permanent fastener methods may include without limitation: pins, clamps, screws, bolts, welds, rivets, adhesives, snap-lock, or various other. The present embodiment preferably illustrates downspout connector 6 with four fasteners 9. However, those skilled in the art may readily recognize use of more or fewer fasteners 9, as well as vertical, horizontal, diagonal, or various other fastener positions.

In the preferred embodiment, generally two fastener shafts on top and two on bottom of connector interface 10 provide a mechanism for fasteners 9 to secure invention to downspout. The general preferred fastener shaft 18 size, shape, and proportions are presented in the present embodiment. Preferred fastener shaft 18 body material is plastic as part of an overall one-piece molded device. In alternate embodiments, multiple shafts, position, and dimensions on the present invention may be realized. For example, alternate embodiments may include without limitation one or more fastener shafts 18 positioned on one or all sides of connector interface 10. The present invention encompasses all fastener shaft 18 variations described in present embodiment, in addition to numerous methods and structures of attachment that may be recognized in the implementation or manufacturing process.

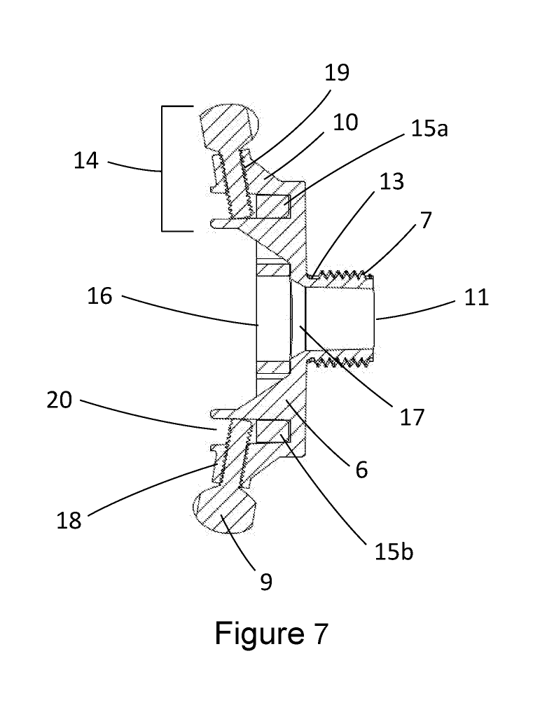

In the preferred embodiment, a body sidewall 21, comprised of thickened material, encompasses back half of connector interface 10 perimeter. Body sidewall 21 functions to position gasket 15 into place during assembly and shield gasket material from weather conditions such as precipitation, heat, cold, and ultraviolet light. Preferred body sidewall 21 material is plastic, as part of an overall one-piece molded device. In other examples, the gasket 15 may be made of a compressible material (e.g., a rubber foam), the outer edges of which may be squeezed between the downspout connector 6 and the downspout to aid in preventing rain water from spilling from the downspout connector 6. As shown in the cross-sectional view of FIG. 7, the gasket 15 may include gasket perimeter portions 15a and 15b located at the perimeter of the downspout connector 6 and inside the tongue-and-groove channels 20, such that the gasket perimeter portions 15a and 15b may be compressed when the downspout connector 6 is coupled to the downspout.

In the preferred embodiment, a gasket 15 is embedded generally covering back half of connector interface 10, with gasket perimeter portions 15a and 15b around tongue-and-groove channel walls 24, channel wall gussets 22, and ducts 17. Gasket 15 functions to provide a flush and watertight seal when downspout connector 6 joins to downspout. Preferable gasket 15 material is commercially produced foam rubber, die cut, and assembled post-injection molding of the device. Preferably gasket 15 attaches to connector interface 10 by way of commercially prepared pressure sensitive adhesive. In alternate embodiments, attachment mechanisms may include temporary or permanent glues, tapes, cements, bonding agents, or various other adhesives. Likewise, gasket material may also be comprised of silicone, foam, rubber, neoprene, blends, or other. Gasket 15 is preferably shown as one continuous piece; however alternate embodiments may include sections, cut-outs, noncontiguous, or various other shapes, thickness, and formations. In some examples, the outer edges of which may be squeezed between the downspout connector 6 and the downspout to aid in preventing rain water from spilling from the downspout connector 6. As shown in the cross-sectional view of FIG. 7, the gasket 15 may include gasket perimeter portions 15a and 15b located at the perimeter of the downspout connector 6 and inside the tongue-and groove channels 20, such that the gasket perimeter portions 15a and 15b may be compressed when the downspout connector 6 is coupled to the downspout.

Those skilled in the art will readily recognize various different methods of downspout connector 6 attachment. Although it is preferred to join the downspout connector 6 onto general end of downspout, it is conceivable to attach invention up to and beyond downspout elbow and multiple inches into a drainpipe. Many alternate variations of said attachment method exist in temporary or permanent form. For example, alternate embodiments may include downspout connector 6 attachment by hardware mechanisms such as nuts, bolts, screws, rivets, pins, self-tightening devices, or other. Preferably downspout is attached by hand using metal fasteners 9. However, alternate downspout connector 6 attachment methods using mechanical or physical mechanisms may generally include friction, wedging, hook and loop fasteners, snap-lock, elastic bands, sleeve-like devices, connectors, adhesives, compression, welding, or various others. Likewise, tongue-and-groove attachment structure 14 is preferably positioned on top and bottom of connector interface 10. It is also conceivable to position said system on left and right sides, all four sides, or other combinations. All said downspout connector 6 attachment alternative embodiments are in accordance without limitation of present invention.

FIG. 6 illustrates an orthographic side view of the present invention. In the present embodiment, downspout connector 6 comprises of connector interface 10, providing a blocking mechanism when joined to downspout, enabling water to channel through ducts (see FIG. 2). On top and bottom of connector interface 10 is a tongue-and-groove attachment structure 14 showing components: tongue-and-groove channels 20, channel walls 24, channel wall gussets 22, fasteners 9, and fastener shafts 18.

In the present embodiment, tongue-and-groove channels 20 permit downspout edge (“tongue”) to join attachment channel (“groove”). The tongue-and-groove channel 20 and its corresponding channel wall 24 guide downspout into position, enabling proper fit. Tongue-and-groove channels 20 are situated generally on top and bottom of backside connector interface 10. Channel wall gussets 22 strengthen channel wall 24, reducing bending, twisting, and other forces during attachment process.

With downspout connector 6 fitted onto downspout, fasteners 9 are inserted into fastener shafts 18 for purpose of securing device. Hand-tightened fasteners 9 secure downspout connector 6 to downspout by pinching pressure, with no need for mechanical methods or physical alterations.

In the preferred embodiment, two fastener shafts 18 on top and two on bottom of connector interface 10 provide a mechanism for fasteners 9 to secure invention to downspout. The preferred fastener shaft 18 size, shape, and proportions are presented in the embodiment. The present embodiment also shows a preferable 30° fastener shaft 18 angled back towards the downspout. The angled position enables greater pinching force, allowing fastener 9 tip to securely grip the downspout. The present invention is not limited by 30°, and those skilled in the art will readily recognize fewer or multiple angle variations for both tongue-and-groove attachment structure 14 and fastener shaft 18, including a combination of multiple angles, as well as a fastener shaft 18 that forms a straight, perpendicular 90° angle with the horizontal plane of the connector interface 10. All angle variations for both tongue-and groove attachment structure 14 and fastener shaft 18 positions are within the scope of the present invention.

An elevated base 13 of thickened material situated on front half of connector interface 10 encompasses male-thread hose connectors 7 for purpose of structural support, such as reducing shearing and weight stress. Conventional water hoses join hose connectors 7 and fluid is distributed to preferred locations.

The present embodiment presents external support structures that may include ribbing, gussets, and other structural features with purpose to increase integral strength of the device. The structures function to reduce stresses such as bending and shearing of connector interface 10 and downspout connector 6. The preferred shape, size, and proportion of external support structures are shown in present embodiment. Preferably half-round external front ribbing 23a is located on the vertical plane of connector interface 10, intersecting connector bases 13. Front ribbing 23a joins continuously with top ribbing 23b (see FIG. 4). Top ribbing 23b is generally situated on top and bottom of connector interface 10 and joins with fastener gussets 12 to reinforce connector interface 10 with fastener shafts 18. Fastener gussets 12, generally triangular shaped, join with top ribbing 23b, connecting fastener shafts 18 to horizontal plane of connector interface 10 and provide additional structural support. Alternate embodiments may include without limitations external support structures comprised of different sizes, shapes, materials, and proportions. For example, gussets and ribbing may be half-round, rectangular, triangular, cylindrical, or various other shapes and sizes. Support structures may also be presented as beveled, flat, raised, tapered, or various other forms. In addition, support structures may be arranged in a grid, rectangular, spherical, or various other configurations. Preferred material is molded plastic as part of an overall one-piece molded device. However, support structures may be constructed of metal, wood, ceramic, composite, plastic, rubber, or various other materials. Similarly, all support structure variations, or those realized by the skilled art, are within the scope of the present invention.

FIG. 7 presents an orthographic partially cut side view of the present invention. In the present embodiment, downspout connector 6 comprises of connector interface 10, providing a blocking mechanism when attached to downspout, enabling fluid to channel through duct entrance 16. On top and bottom of connector interface 10 is tongue-and-groove attachment structure 14. The said system consists of tongue-and-groove channels 20 permitting downspout edge (“tongue”) to join attachment channel (“groove”). Fasteners 9 are situated inside fastener shafts 18 atop the tongue-and-groove channels 20. Hand-tightened fasteners 9 secure downspout connector 6 to downspout by pinching pressure. Fluid transfers freely through ducts 17 towards front half of connector interface 10. An elevated base 13 on front half of connector interface 10 provides structural support for male-threaded hose connector 7. Fluid transfers out device through duct exit 11. Conventional water hoses join hose connectors 7 and distribute fluid to desired locations.

In the present embodiment, tongue-and-groove attachment structure 14 includes commercially available fasteners 9 fitted into fastener shafts 18 by way of internal threads 19. Internal threads 19 provide a method for fasteners 9 to secure downspout connector 6 to downspout. Preferable internal thread 19 material is commercially available metal inserts with female threads, as part of an overall one-piece molded device. The preferred internal thread 19 material and method are merely examples of various different embodiments. Those skilled in the art will readily recognize multiple methods of producing internal threads 19. For example, alternate methods may include inserts, tubes, compression, wedge, non-threads, male threads, injection molded, or other made from plastic, metal, ceramic, composite, or various other materials. Such alternate internal thread 19 methods may be joined to tongue-and-groove attachment structure 14 using adhesives, friction, snap-lock, expansion, wedging, or various other methods. All alternate embodiments are within the scope of the invention.

In the present embodiment, the gasket 15 (see FIG. 5) may include gasket perimeter portions 15a and 15b located at the perimeter of the downspout connector 6 and inside the tongue-and-groove channels 20, such that the gasket perimeter portions 15a and 15b may be compressed when the downspout connector 6 is coupled to the downspout, enabling a watertight seal.

All aforementioned embodiments of the present invention imply use with a conventional downspout having generally a rectangular opening. Alternate embodiments incorporate commercial or customized downspouts constructed in various shapes and sizes such as circular, round, half-round, triangular, square, or various other. All downspouts including materials and devices with similar function, regardless of size and shape are within the scope of the present invention.

The present invention has been described above by way of examples and illustrated figures. The preferred construction method and materials, features, and intended use have been presented in detail. In addition, some of the numerous alternate embodiments have been presented to illustrate the scope of the invention. However, those skilled in the art may recognize various different modifications, materials, methods, and implementation techniques. For example, the downspout connector attachment method may be modified in size, shape, or position using different configurations. In addition an alternate method for sealing downspout connector to downspout may be recognized in the same spirit of the present invention. Finally, overall general shape, size, and dimensions of downspout connector may be recognized in different form, yet still provide the same function as downspout connector. All such modifications, alternatives, and equivalents are incorporated in scope and body of the present invention.

What is claimed as new is follows:

1. A downspout connector for diverting fluid from a downspout comprising:
a body having first wall for interfacing with a downspout exit hole and a sidewall for overlapping with the outer wall of the downspout;
a tongue-and-groove attachment structure adjacent to said sidewall for fastening said connector to said downspout at least one duct connected to said first wall for receiving fluid from said downspout; and
at least one hose connector on said at least one duct for receiving said fluid from said downspout.

2. The downspout connector of claim 1, wherein said at least one hose connector includes an elevated base having a greater diameter and thicker walls than a distal portion of said at least one hose connector.

3. The downspout connector of claim 1, wherein said at least one hose connector is a male-threaded hose connector, enabling attachment of conventional female-threaded water hoses for water distribution.

4. The downspout connector of claim 1, at least one hose connector comprises a first hose connector and a second hose connector, wherein said first and second hose connectors are positioned on the horizontal midline.

5. The downspout connector of claim 1, wherein said at least one duct comprises a first duct and a second duct.

6. The downspout connector of claim 5, wherein said first and second ducts are positioned on a horizontal midline of said downspout connector.

7. The downspout connector of claim 1, wherein said tongue-and-groove attachment structure includes at least one reversible fastening mechanism for reversibly attaching said downspout connector to said downspout, wherein no physical modification of said downspout is necessary to attach said downspout connector.

8. The downspout connector of claim 1, wherein said tongue-and-groove attachment structure includes a channel for receiving a wall of said downspout.

9. The downspout connector of claim 8, further comprising a gasket on an interfacing side of said body, such that the gasket is between said body and said downspout when said downspout connector and said downspout are coupled.

10. The downspout connector of claim 8, wherein walls of said channel are connected to said body and are supported by gussets between said channel walls and said body.

11. The downspout connector of claim 9, wherein a portion of said gasket is located in said channel.

12. The downspout connector of claim 9, in which gasket interface provides watertight seal between connector interface and downspout.

13. The downspout connector of claim 9, wherein said gasket is positioning within the sidewalls of said body and said wall of said downspout when said downspout connector and said downspout are coupled together, thereby protecting said gasket from weather.

14. The downspout connector of claim 9, in which gasket adheres to said body.

15. The downspout connector of claim 1, further comprising ribbing between said tongue-and-groove attachment structure and said at least one channel to provide structural support.

16. The downspout connector of claim 9, wherein said gasket has a thickness that is greater than or equal to the width of said sidewall.

17. The downspout connector of claim 9, wherein said gasket is made from a compressible material.

18. The downspout connector of claim 17, wherein said gasket is between said body and said downspout when said downspout connector and said downspout are coupled and said gasket is compressed between said downspout and said body.
